(19) United States
(12) Patent Application Publication
(10) Pub. No.: US 2008/0011428 A1
(43) Pub. Date: Jan. 17, 2008

(54) ADHESIVE TROWEL

(75) Inventor: Brian H. Turner, Walton, KY (US)

Correspondence Address: WOOD, HERRON & EVANS, LLP, 2700 CAREW TOWER, 441 VINE STREET, CINCINNATI, OH, 45202, US

(73) Assignee: NORTH AMERICAN TILE TOOL COMPANY, Hebron, KY (US)

(21) Appl. No.: 11/457,917

(22) Filed: Jul. 17, 2006

(51) Int. Cl. B44C 7/00

(52) U.S. Cl. 156/574

(57) ABSTRACT

A trowel designed to apply adhesive to a wall or floor includes a grooved cylinder along one edge. The grooves extend completely around the cylindrical surface and are uniform in size allowing one to apply a uniform amount of adhesive onto a surface regardless of the angle of the trowel relative to the surface.

### BACKGROUND OF THE INVENTION

Adhesives, including cementitious adhesives such as Thinset, are used to adhere tile, linoleum, and other wall and floor coverings to walls or floors.

It is very important that a uniform amount of adhesive be applied. If an uneven amount of adhesive is applied, the final coated surface, i.e., the tile or linoleum, may be uneven. There may be dips and valleys. Alternately, there may not be enough adhesive to bond the tile or linoleum to the surface. The covering material can come loose or even break.

Typically, notched trowels are used to apply the adhesive to a surface. A trowel with a certain notch size is selected so that the appropriate amount of adhesive is applied. For example, certain trowels have a ½-inch notch, whereas others may have a ⅜-inch or even a ⅛-inch notch. The larger the notch the more adhesive is applied.

Because these are simply notches along the edge of a planar surface, the angle of the trowel will also affect how much adhesive is applied.

Most of these trowels are designed to apply the adhesive with the trowel at a 45° angle relative to the surface. For a very skilled tile applicator or linoleum applicator, this may not present a problem. But, for the individual who is working in his own home and is not a professional, maintaining the 45° angle can be a problem. As a result, the right amount of adhesive is frequently not applied.

### SUMMARY OF THE INVENTION

The present invention is premised on the realization that a trowel which has a grooved cylindrical edge can be used to apply a uniform layer of adhesive regardless of the angle of the trowel. This will insure a uniform amount of adhesive with uniform-sized ridges of adhesive is applied over a surface.

The objects and advantages of the present invention will be further appreciated in light of the following detailed description and drawings, in which:

### BRIEF DESCRIPTION OF THE DRAWINGS

FIG. 1 is a perspective view of the present invention;

FIG. 2 is an underside plan view of the present invention;

FIG. 3 is an enlargement of a portion of FIG. 2;

FIG. 4 is an end view of the present invention in use;

FIG. 5 is a perspective view of the present invention in use; and

FIG. 6 is a cross sectional view taken at line 6-6 of FIG. 5.

FIG. 7 is a perspective view of an alternative embodiment of the present invention.

FIG. 7A is a cross sectional view broken away of the trowel shown in FIG. 7.

### DETAILED DESCRIPTION OF THE INVENTION

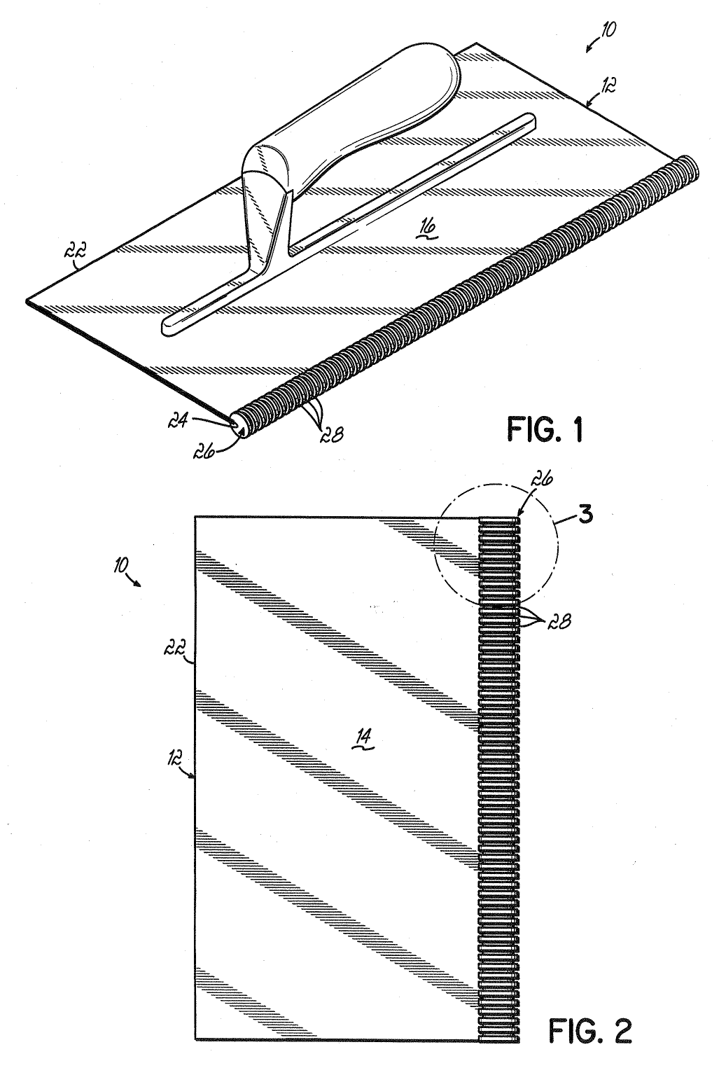

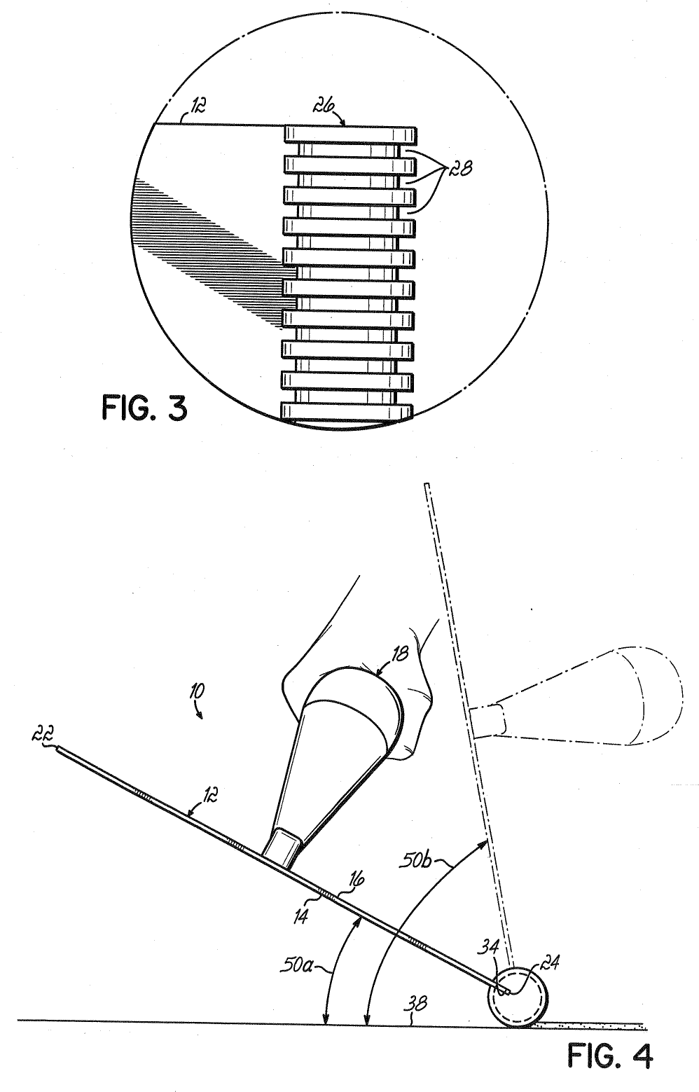

As shown in FIG. 1 a trowel 10 includes a rectangular planar member 12 which is generally formed of metal or other material such as rigid plastic. The member 12 includes a first planar side 14 and a second planar side 16. Attached to the second side 16 is a handle 18 which extends parallel to first and second edges 22 and 24. Second edge 24 includes a cylinder 26 which has a plurality of evenly spaced uniform grooves 28. Each groove will have a width and a depth. The width and depth of all the grooves 28 should be the same and constant, as can be seen from FIG. 3. Generally, the distance between grooves is equal to the width of the grooves.

The grooves 28 in cylinder 26 should extend from below said first side 14 and, preferably, should extend around and up to or above said second side. As shown, the grooves 28 in cylinder 26 extend 360°, which is optimal. Likewise, a cylinder is shown. As described later, a partially formed cylinder will function. For purposes of the present invention, any grooved curved surface can be used in place of the grooved cylinder 26. The grooves have a constant depth so that an even amount of mastic or adhesive is applied regardless of the angle of the trowel during application. Further the grooves extend only partially through the cylinder 26. If they extended through the central access of cylinder 26, at certain angles excess mastic would be applied.

The cylinder 26 can be formed from plastic or metal. Generally, it will be a solid cylinder with the grooves 28 formed around the cylinder. As shown in FIG. 4, an axial groove 34 is formed in the cylinder 26 and the second edge 24 of trowel 10 is fixed within the axial groove 34. This can be held in position with adhesive or can be welded for a metal to metal fit.

The trowel 10 is used to apply adhesive 42 onto a surface 38. For use in the present invention, any adhesive may be used, particularly those used to apply tile, linoleum and other surface coverings to walls and floors. Generally, the adhesives are relatively viscous materials and will include flooring adhesives, tile adhesives including cementitious type tile adhesives commonly referred to as Thinset.

To apply the adhesive, one grasps the handle 18 of the trowel 10 and spreads adhesive loosely to the floor using the first edge 22. This will provide an uneven coating of adhesive on the surface 38. One then spreads the adhesive out into rows 46, using the cylinder 26.

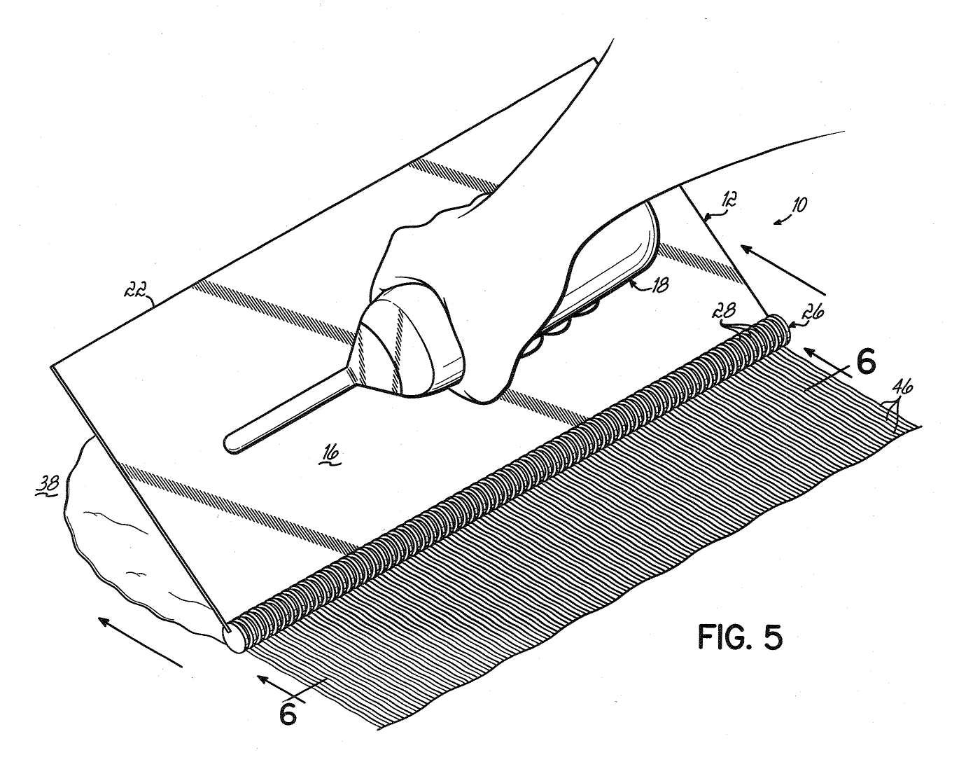

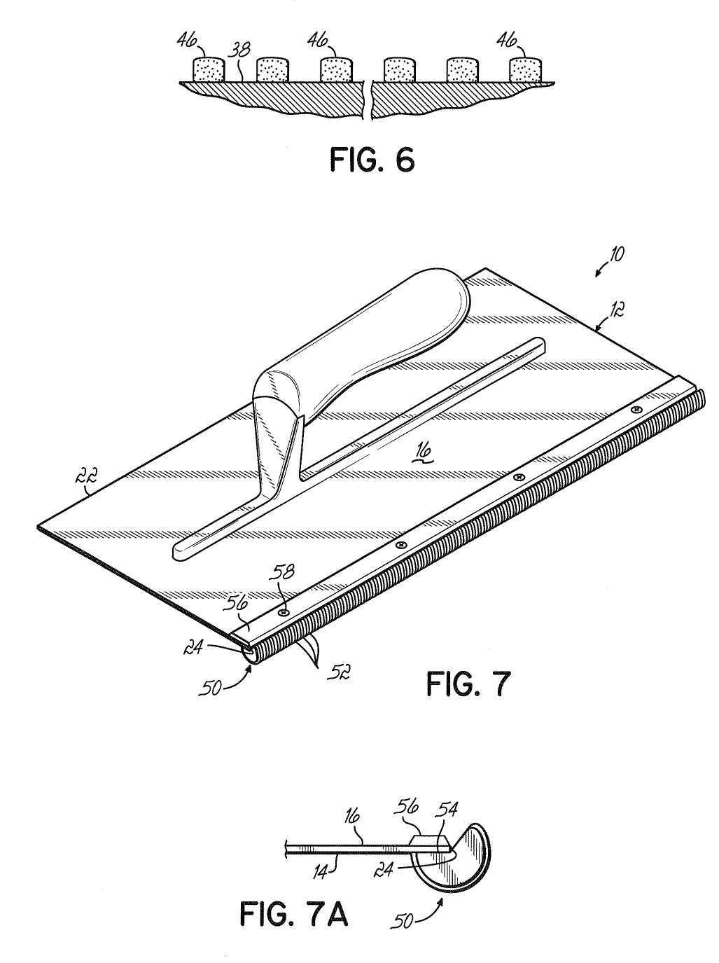

As shown in FIGS. 5 and 6, this will result in a uniform coating of parallel rows of adhesive on surface 38. As shown in FIG. 4, the same amount of adhesive will be applied regardless of the angle 50a or 50b of the trowel 10 or member 12 relative to the surface 38. Once the adhesive is applied to the floor surface 38, the surface covering material, such as tile, linoleum, or parquet, can be applied to the surface 38.

An alternative embodiment of the trowel of present invention is shown in FIG. 7. In this embodiment, the cylinder 26 is replaced with an elongated member 50 which provides a curved surface along the edge 24 of trowel 10. The curved surface includes grooves 52 which are the same as the grooves 28 in FIG. 1. The curved grooved member 50 includes a planar surface 54 that seats on the bottom surface 14 of the trowel. This is fastened to the trowel with a fastening strip 56 with countersunk screws 58 extending through the fastening strip 56 through the edge of the trowel into the curved groove member 50. This provides the same advantages of the trowel shown in FIGS. 1-5 but facilitates attachment of the curved grooved member 50 to the edge of the trowel. It provides for the grooved surface extending from below the bottom surface 14 of the trowel to above the upper surface 16 of the trowel. It should be noted that the grooves do not have to extend all the way to the bottom surface 14 since it would actually be impossible for one to apply grout or mastic with the portion of the grooved member 50 immediately adjacent to the bottom surface 14. The grooves need to start about 10 to 20° from the bottom surface 14 and simply extend up to or above the surface 16 to work best in the present invention.

This allows an inexperienced individual to apply the same amount of adhesive uniformly across a surface 38. This will, in turn, insure that the appropriate amount of adhesive is applied. This will be determined by selecting a trowel 10 with the appropriate sized grooves 28 in the cylinder 26. Using trowel 10 insures that the there is adequate adhesive at all locations so that the surface covering material does not separate from the surface 38 or even, in certain circumstance, break due to lack of adhesive under certain localize portions.

This has been a description of the present invention along with the preferred method of practicing the present invention. However, the invention itself should only be defined by the appended claims, WHEREIN

I claim:

1. A trowel configured to apply adhesive to a planar surface comprising
a planar member having a first planar side and a second side, and a first edge and opposed second edge;
and said second edge comprising a grooved curved member having grooves extended a uniform depth through a curved surface of said member and whereas said grooves do not extend through a central axis of said curved member.

2. The trowel claimed in claim 1 wherever said grooved curved member extends from below said first planar surface to above said second planar side.

3. The trowel claimed in claim 2 wherein said first edge is linear.

4. The trowel claimed in claim 1 further comprising a handle extended from said second side.

5. The trowel claimed in claim 4 wherein said handle extends parallel to said grooved cylindrical member.

6. The trowel claimed in claim 1 wherein grooves in said grooved cylindrical member start at said first side and extend more than 180 degrees.

7. The trowel claimed in claim 1 wherever said grooved curved member has a planar portion and wherever said grooved curved member is fixed to said trowel with said first portion fixed to said first edge.

8. A method of applying a uniform amount of an adhesive on a surface comprising applying said adhesive to said surface and spreading said adhesive over said surface with an grooved curved member.

9. The method claimed in claim 8 wherein said surface is a floor.

10. The method claimed in claim 8 wherein said surface is a wall.

11. The method claimed in claim 8 further comprising applying a covering material over said adhesive.

12. The method claimed in claim 10 wherein said covering material is selected from the group consisting of floor coverings and wall coverings.

13. The method claimed in claim 11 wherein said floor covering is selected from wood, tile and linoleum.
